(19) United States
(12) Patent Application Publication
(10) Pub. No.: US 2001/0045145 A1
(43) Pub. Date: Nov. 29, 2001

(54) Keyring tool

(76) Inventor: Larry K. Legg, Perry, OH (US)

Correspondence Address: Renner, Otto, Boisselle & Sklar, LLP, 19th Floor, 1621 Euclid Avenue, Cleveland, OH, 44115-2191, US

(21) Appl. No.: 09/792,141

(22) Filed: Feb. 22, 2001

Related U.S. Application Data
(60) Provisional application No. 60/191,526, filed on Mar. 23, 2000.

(51) Int. Cl. B25B 23/00

(52) U.S. Cl. 81/440

(57) ABSTRACT

A tool comprising a handle and a plurality of tool members which is attachable to a keyring. The handle includes a plurality of recessed pockets and the tool members each include a different tool bit portion, such as a straight blade screwdriver, a Phillips screwdriver, a hexagonal wrench, and/or a starshaped wrench. The tool members are selectively movable between a stored position whereat the tool bit portion is stored within one of the plurality of recesses and an extended position whereat the tool bit portion is aligned with a longitudinal axis of the handle whereby the selected tool bit portion may used to perform a tooling task.

### RELATED APPLICATIONS

This application claims priority under 35 U.S.C. §119(e) of U.S. Provisional Patent Application No. 60/191,526 filed on Mar. 23, 2000. The entire disclosure of this earlier application is hereby incorporated by reference.

### FIELD OF THE INVENTION

The present invention relates generally as indicated to a key ring hand tool and more specifically to a hand tool which is constructed to conveniently store a variety of different tool bit portions and which can be conveniently carried on a keyring.

### BACKGROUND OF THE INVENTION

A multitude of hand tools are known which are useful in accomplishing a variety of tasks, such as a flat blade screwdriver, a Phillips head screwdriver, a hexagonal wrench and/or an otherwise shaped wrench. An assortment of these tools are commonly stored in one location, such as a tool chest, so that they can be withdrawn and used for the tooling task presented. This arrangement works quite well in some settings, such as an industrial work station or home work bench, where these tasks are repeated over and over again in the course of completing a project.

During day-to-day activities, tasks are sometimes encountered which require the use of a specific screwdriver or wrench. Very often, the situation occurs remote from the tool chest and requires only a single use of a hand tool. Additionally or alternatively, tasks are also encountered which require the use of a specific hand tool during traveling With particular reference to outdoor travel activities such as camping, hiking, and biking, these types of tools may be necessary to set-up camp and/or maintain equipment. While traveling with a tool chest is one solution, this is probably not practical since most travelers (especially campers, hikers, and bikers) prefer to pack as light as possible.

### SUMMARY OF THE INVENTION

The present invention provides a tool which is keyring-attachable whereby it can be conveniently carried in a pocket or purse so that, when a tooling task presents itself, the tool is available to perform the task.

More particularly, the present provides a tool comprising a handle and a plurality of tool members. The handle includes a plurality of recessed pockets and the tool members each include a different tool bit portion. For example, the tool bit portions may include different sizes of straight blade screwdrivers, Phillips screwdrivers, a hexagonal wrenches, and/or a star-shaped wrenches. The tool members are selectively movable between a stored position whereat the tool bit is stored within one of the plurality of recesses and an extended position whereat the tool bit portion is aligned with a longitudinal axis of the handle whereby the selected tool bit portion may used to perform a tooling task.

The handle preferably has a spherical shape whereby its longitudinal axis extends between a first pole and a second pole. The tool bits extend radially outward from one of the first and second poles when in the extended position. Specifically, some of the tool bits extend radially outward from the first pole when a selected tool member is in its extended position and the rest of the tool bits extend radially outward from the second pole when a selected tool member is in its extended position. The spherical shape of the handle, along with axial alignment of the extended tool bit portion and the recessed geometry of the pockets, allows the handle to be gripped in manner providing a good transmission of manual power from the handle to the tool bit portion.

The tool preferably includes eight tool members whereby the handle preferably includes eight recessed pockets. A first set of the pockets are longitudinally positioned so that the tool bit portions of the corresponding tool members extend radially outward from the first pole when a selected tool member is in its extended position. A second set of the pockets are longitudinally positioned so that the tool bit portions of the corresponding tool members extend radially outward from the second pole when a selected tool member is in its extended position. The pockets in the first set are laterally aligned 90° apart from each other and the pockets in the second set are laterally aligned 90° apart from each other. Additionally, the pockets in the first set are laterally offset approximately 45° relative to the pockets in the second set.

Each of the pockets preferably includes a concave recess and a groove. A distal end of the tool bit portion is positioned within the concave recess when the corresponding tool member is positioned in its stored position. The grooves each extend from a wall of the concave recess and form an interior wall parallel with the handle's longitudinal axis and a perpendicular wall extending radially inward therefrom at a location longitudinally removed from the relevant pole. The grooves of the first set of pockets collectively form a cross-shaped core, the grooves of the second set of pockets collectively form a cross-shaped core, and the cross-shaped cores are laterally offset 45° relative to each other.

The handle includes openings which define passageways between each pair of adjacent longitudinally aligned pockets. The tool preferably additionally comprises pivot pins which extend through the openings to pivotally attach the tool members to the handle.

The tool may further comprise springs which resiliently bias the tool members in the stored position and the extended position. The springs and the tool members preferably have a complimentary notch-groove arrangement therebetween when the tool members are in the stored position and the extended position. The preferred springs each have a cross shape and are sized for insertion into a cross-shaped cavity adjacent each of the poles.

The preferred tool members each additionally comprise a proximate mounting portion pivotally attached to the handle and an intermediate portion between the proximate mounting portion and the tool bit portion. The intermediate portion and the tool bit portion extend radially outward from the handle and are aligned with the handle's axis when the selected tool member is in its extended position. The proximate mounting portion includes the pivot axis about which the selected tool member is rotated (preferably approximately 180°) for conversion between the stored position and the extended position. The pivot pins extend through an opening in the proximate mounting portion of the respective tool member.

The proximate portion of the tool member is shaped to coordinate with the springs and is also shaped to coordinate, when in its extended position, with the proximate mounting portion of a diametrically adjacent tool member. In the preferred embodiment, the proximate mounting portion of each of the tool members includes a semi-circular wall section, first and second detent wall sections, and a concave curved wall section. The semi-circular wall section is positioned tangentially relative to an adjacent longitudinal edge of a respective quadrant of a cross-shaped cavity in the handle when the tool member is in its stored position, and is rotated but remains within the quadrant when the tool member is in its extended position. The first detent wall section captures a notch of the spring when the tool member is in the stored position to prevent inadvertent pivoting of the tool member from the pocket. The second detent wall section captures the notch of the spring when the tool member is in the extended position to lock the selected tool member in its extended position. The concave curved wall section mates with a semi-circular section of the diametrically adjacent tool member when the selected tool member is in the extended position to brace the tool member in position for use of the tool bit portion to perform the tooling task.

These and other features of the invention are fully described and particularly pointed out in the claims. The following descriptive annexed drawings set forth in detail a certain illustrative embodiment of the invention, these embodiments being indicative of but one of the various ways in which the principles of the invention may be employed.

### DRAWINGS

FIG. 1 is a perspective view of a tool according to the present invention, the tool being shown with one its tool members in an extended position and the rest of its tool members in a stored position.

FIG. 2 is an exploded view of the tool.

FIG. 3 is a front view of the tool.

FIG. 4 is a sectional view of the tool as seen along line 4-4 in FIG. 1.

FIG. 5 is a sectional view of the tool as seen along line 5-5 in FIG. 1.

FIG. 6 is a top view of the tool's handle as see from line 6-6 in FIG. 2.

FIGS. 7A-7H are perspective views of the different tool members.

FIG. 8 is a perspective view of the tool attached to a keyring.

### DETAILED DESCRIPTION

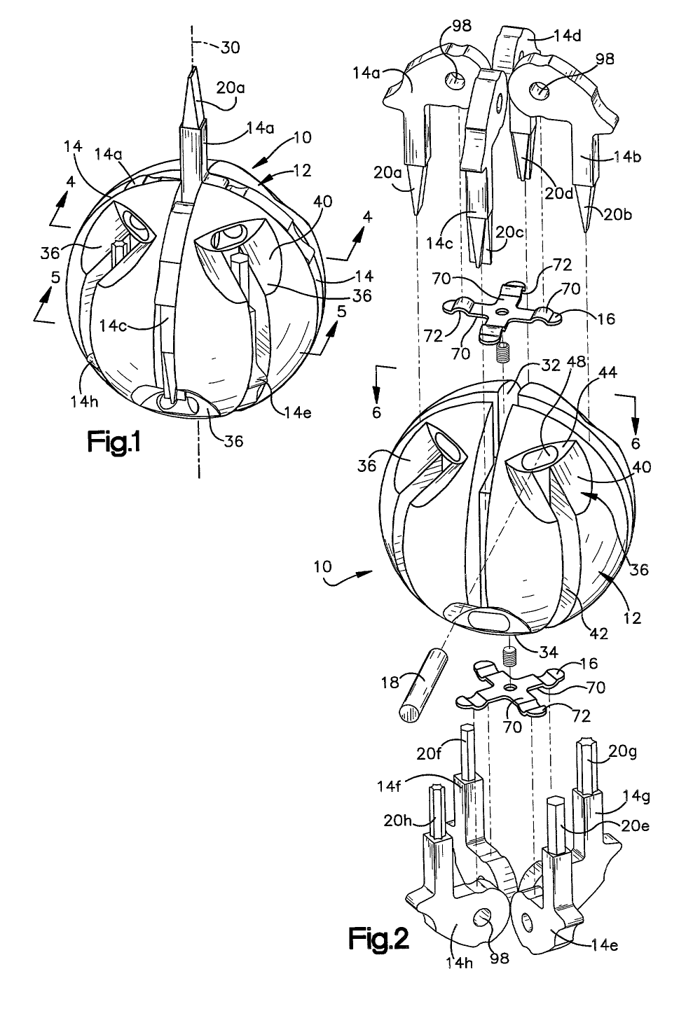

Referring now to the drawings in detail, a tool 10 according to the present invention is shown. (FIGS. 1-6.) The tool 10 includes a handle 12, tool members 14, springs 16, and pivot pins 18. (FIG. 2.) The tool members 14 are attached to the handle 12, via the springs 16 and pivot pins 18, in such a manner that they are each selectively movable between a stored position and extended position. (FIGS. 1 and 3-5.)

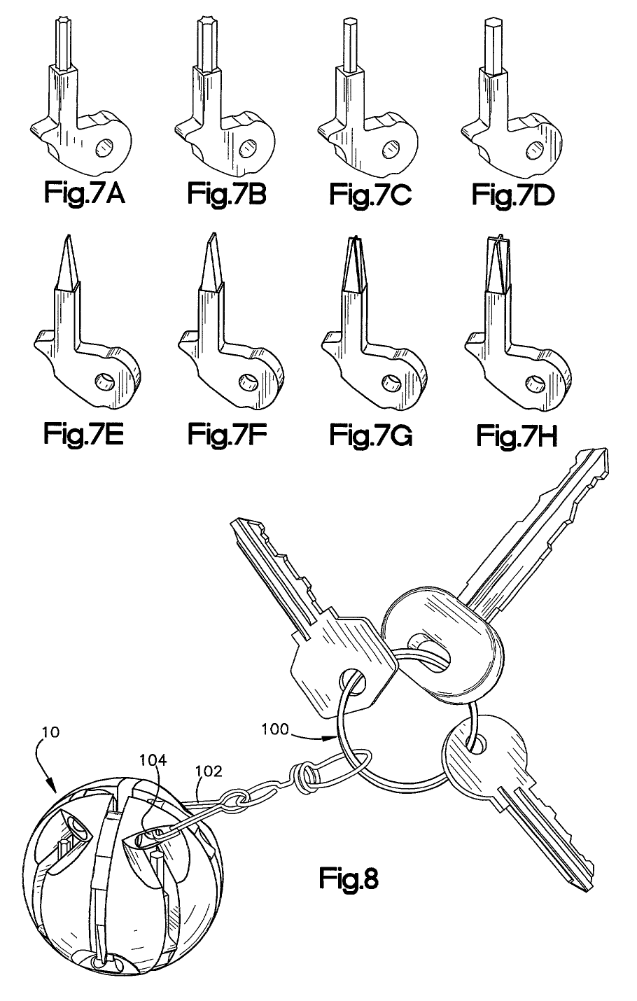

The tool members 14 each include a tool bit portion 20 which is exposed when the respective tool member 14 is in an extended position whereby the selected tool bit portion 20 may used to perform a tooling task. (FIGS. 1, 3 and 4.) In the preferred and illustrated embodiment, the tool 10 includes eight tool members 14a-14h and the tool bit portions 20 are eight different types of tools. For example, the tool bit portion 20a is a straight blade screwdriver, tool bit portion 20b is a smaller straight blade screwdriver, tool bit portion 20c is a Phillips screwdriver, tool bit portion 20d is a smaller Phillips screwdriver, tool bit portion 20e is a hexagonal wrench, tool bit portion 20f is a smaller hexagonal wrench, tool bit portion 20g is a star-shaped wrench, and tool bit portion 20h is a smaller star-shaped wrench. (FIGS. 2 and 7.)

The handle 12 has an overall spherical shape whereby it has an axis 30 extending between a first pole 32 and a second pole 34. (FIGS. 1-3 and 6.) The handle 12 includes a plurality of recessed pockets 36 that extend in the longitudinal direction between the poles 32 and 34. (FIG. 2.) One tool member 14 is contained within one of the pockets 36 when the tool member 14 is in the stored position. When the tool member 12 is in the extended position, the corresponding tool bit portion 20 extends radially outward from one of the poles 32/34. (FIGS. 1 and 3-5.)

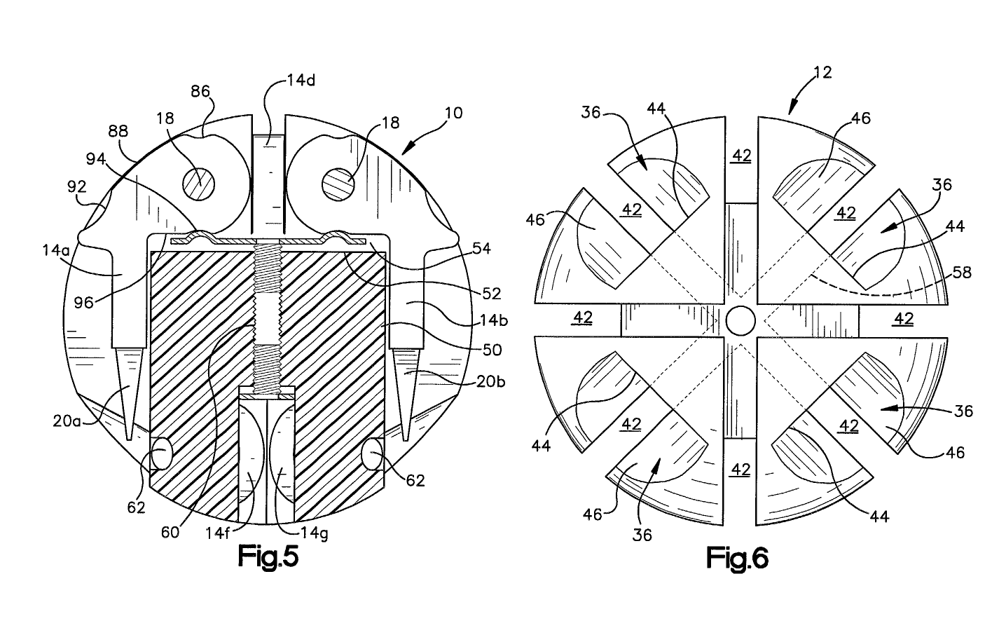

As was indicated above, the preferred and illustrated tool 10 includes eight tool members 14 whereby the preferred and illustrated handle 12 includes eight recessed pockets 36. Four of the pockets 36a-36d are longitudinally positioned so that the corresponding tool members 14a-14d will extend radially outward from the first pole 32 when in the extended position. The other four pockets 36e-36h are longitudinally positioned so that the corresponding tool members 14e-14h will extend radially outward from the second pole 34 when in the extended position. The pockets 36a-36d are laterally aligned 90° apart from each other. The pockets 36e-36h are also laterally aligned 90° relative to each other and are shifted 45° relative to the pockets 36a-36d. (FIG. 2.) The pockets 36 each include a concave recess 40 and a groove 42. (FIGS. 1-6.) The concave recess 40 is roughly in the shape of a quarter football or quarter watermelon and is defined by an inner wall 44 and a curved wall 46. (FIGS. 2 and 6.) The essentially flat inner wall 44 is positioned parallel with the handle's longitudinal axis 30 and includes an oblong opening 48. (FIG. 6 and FIG. 2.) The curved wall 46 extends radially outward from the inner wall 44 and is centrally separated by the groove 42. (FIG. 6.)

The grooves 42 each extend from the curved wall 46 to the opposite pole 32/34. (FIGS. 1-3 and 6.) The groove 42 is shaped so as to form an interior wall 50 parallel with the handle's axis 30 and a perpendicular wall 52 extending radially inward therefrom at a location longitudinally down/up from the relevant pole 32/34. (FIGS. 4-6.) The wall 52 includes an edge lip or flange 54. (FIGS. 4 and 5.) The grooves 42 of the pockets 36a-36d collectively form a cross-shaped core 56 the top of which is a four-platform ledge defined by the radially extending walls 52. (FIGS. 4 and 6.) Likewise, the grooves 42 of the pockets 36e-36h together form a cross-shaped core 58, the bottom of which is four-platform ledge defined by the radially extending walls 52. The cross-shaped cores 56 and 58 are laterally shifted 45° relative to each other and a coaxial bore 60 extends through both cross-shaped cores. (FIG. 6.)

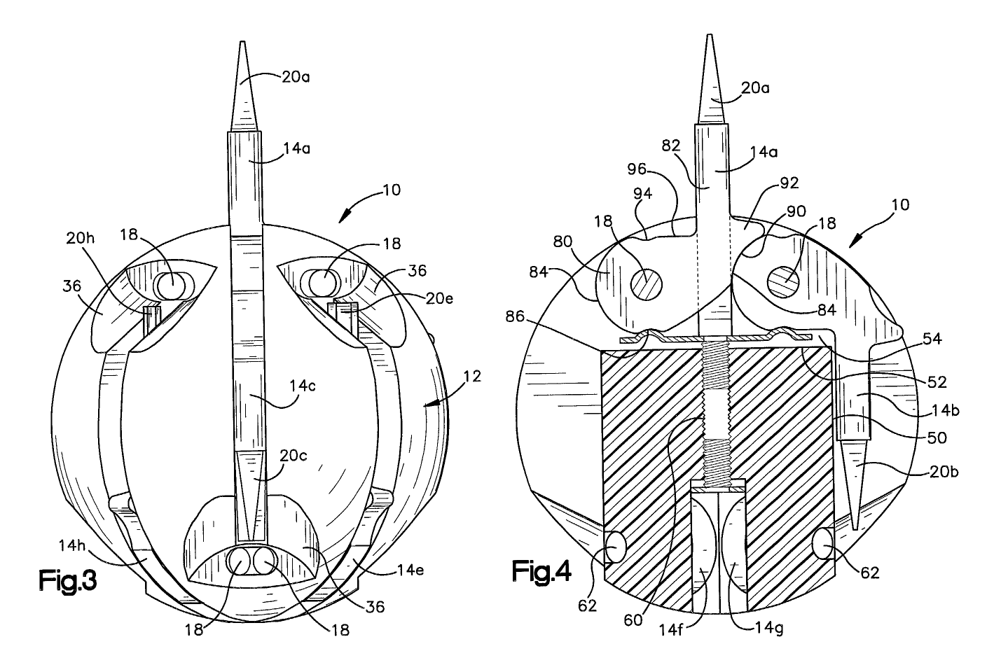

Openings or slots 62 are formed in the handle 12 to define passageways between adjacent longitudinally aligned pockets 36. (FIGS. 4 and 5.) Specifically, a slot extends between pockets 36a and 36b, a slot extends between pockets 36b and 36c, a slot extends between pockets 36c and 36d, and a slot extends between pockets 36d and 36a. Likewise, a slot extends between pockets 26e and 26f, a slot extends between pockets 26f and 26g, a slot extends between pockets 26g and 26h, and a slot extends between pockets 26h and 26e. More specifically, the slots 62 extend between the oblong openings 48 in the back walls 52 of the recesses 40. The pivot pins 18 extend through the slots 62 to pivotally attach the tool members 14 to the handle 12. (FIG. 1 and 3.)

The springs 16 each have a cross-shape with four legs 70 and each of the four legs 70 has a curved notch 72 thereon. (FIG. 2.) The notches 72 project towards the adjacent pole 32/34. That is, notches 72 on the top spring 16 project towards the pole 32 and the notches 72 on the bottom spring 16 project towards the pole 34. (FIGS. 2, 4 and 5.) An opening 74 is situated on the central intersection of the spring 16 for the purposes of alignment and/or assembly. (FIG. 2.) The legs 70 are sized for insertion into the cross-shaped cavity above/below the cores 56/58 and, in the assembled tool 10, fit within the edge flanges 54 on the walls 62. (FIGS. 4 and 5.)

Each of the tool members 14 includes, in addition to the tool bit portion 20, a proximate mounting portion 80 and an intermediate portion 82. (FIG. 4.) The proximate portion 80 is sized/shaped to be contained within one quadrant of the cross-shaped cavity situated above the core 56/58 when the tool member 14 is in its stored position. Also, the proximate portion 80 contains the pivot axis for conversion of the tool member 14 between its stored and extended positions. Still further, the proximate portion 80 is adapted to coordinate with the spring 16 in the stored and extended positions and to coordinate with the diametrically adjacent tool member 14.

To this end, the proximate portion 80 includes two flat side walls and a contoured end wall. (FIG. 2.) The end wall includes a semi-circular section 84, a detent section 86, a convex curved section 88, a concave curved groove section 90, a tab section 92, another detent section 94, and a straight section 96. (FIGS. 4 and 5.) The pivot pin 18 extends through an opening 98 in the tool member 14 to allow the tool member 14 to be moved between its stored position and its extended position. (FIG. 2.)

When the tool member 14 is in the stored position, the semi-circular section 84 is positioned tangentially relative to the adjacent longitudinal edge of the respective quadrant of the cross-shaped pole cavity. The convex curved section 88 is circumferentially aligned with the outer spherical surface of the handle 12, the concave curved groove section 90 is positioned slightly inward therefrom and the tab section 92 protrudes slightly outward therefrom. The detent section 94 captures the curved notch 72 in the corresponding leg 70 of the cross-shaped spring 16. The straight section 96 is positioned parallel with the adjacent ledge of the platform formed by the top of the cross-shaped core 56. (See tool member 14a in FIG. 5.)

When the tool member 14 is in the extended position, the semi-circular section 84 is rotated 180° within the quadrant of the cross-shaped pole cavity. The detent section 86 captures the curved notch 72 in the corresponding leg 70 of the cross-shaped spring 16. The concave curved groove section 90 mates with the semi-circular section 84 of the diametrically adjacent tool member. (See tool member 14a in FIG. 4.)

The intermediate portion 82 has a rectangular prism shape and extends perpendicularly from the tab section 92 and the straight section 96 of the proximate mounting portion 90. The tool bit portion 20 extends perpendicularly from the intermediate portion 92. When the tool member 14 is in its stored position, the portions 82 and 20 are positioned within the groove 42 substantially parallel to the interior wall 50, with the distal end of the tool bit portion 20 extending slightly into the concave recess 40. When the tool member 14 is in its extended position, the intermediate portion 82 and the tool portion 20 extend radially outward from the handle 12 and are aligned with the handle's axis 30.

When the tool member 14 is in its stored position, the captured relationship between the spring's curved notch 72 and the member's detent section 94 prevents inadvertent pivoting of the tool member 14 from the pocket 26. To convert the tool member 14 from its stored position to its extended position, it is moved radially outward relative to the handle 12 and towards the relevant pole 32/34. This movement may be accomplished by pulling either on the end of the tool bit portion 20 or the protruding tab section 92. When the spring's curved notch 72 is captured by the member's detent section 86, the tool member 14 will be locked in its extended position. The mating between the concave curved groove section 90 and the semi-circular section 84 of the diametrically adjacent tool member braces the tool member 14 in position for use of the portion 20 to perform the tooling task.

As shown in FIG. 8, the tool 10 is attachable to a keyring 100 via a hook 102. The hook 102 passes through an opening 104 in the handle 12 which, in the illustrated embodiment, extends through the concave recess 40 of one of the pockets 36. In this manner, the tool 10 is keyring-attachable whereby it can be conveniently carried in a pocket or purse so that, when a tooling task presents itself, the tool is available to perform the task.

Although the invention has been shown and described with respect to certain preferred embodiments, it is obvious that equivalent and obvious alterations and modifications will occur to others skilled in the art upon the reading and understanding of this specification. The present invention includes all such alterations and modifications and is limited only by the scope of the following claims.

What is claimed is:

1. A tool comprising a handle and a plurality of tool members;
the handle including a plurality of recessed pockets;
the tool members each including a different tool bit portion;
the tool members being selectively movable between a stored position whereat the tool bit is stored within one of the plurality of recesses and an extended position whereat the tool bit portion is aligned with a longitudinal axis of the handle whereby the selected tool bit portion may used to perform a tooling task.

2. A tool as set forth in claim 1, wherein the tool includes eight tool members and the handle includes eight recessed pockets.

3. A tool as set forth in claim 1, wherein the tool bit portions include a straight blade screwdriver, a Phillips screwdriver, a hexagonal wrench, and/or a star-shaped wrench.

4. A tool as set forth in claim 1, wherein the handle has a spherical shape whereby its longitudinal axis extends between a first pole and a second pole.

5. A tool as set forth in claim 4, wherein the tool bits extend radially outward from one of the first and second poles when in the extended position.

6. A tool as set forth in claim 5, wherein a first set of the pockets are longitudinally positioned so that the tool bit portions of the corresponding tool members extend radially outward from the first pole when the selected tool member is in its extended position and wherein a second set of the pockets are longitudinally positioned so that the tool bit portions of the corresponding tool members extend radially outward from the second pole when the selected tool member is in its extended position.

7. A tool as set forth in claim 6, wherein the pockets in the first set are laterally aligned 90° apart from each other and wherein the pockets in the second set are laterally aligned 90° apart from each other.

8. A tool as set forth in claim 7, wherein the pockets in the first set and the pockets in the second set are laterally offset approximately 45° relative to each other.

9. A tool as set forth in claim 8, wherein the pockets each includes a concave recess and a groove and wherein a distal end of the tool bit portion is positioned within the concave recess when the corresponding tool member is positioned in its stored position.

10. A tool as set forth in claim 9, wherein each of the grooves extends from a wall of the concave recess and forms an interior wall parallel with the handle's longitudinal axis and a perpendicular wall extending radially inward therefrom at a location longitudinally removed from the relevant pole.

11. A tool as set forth in claim 10, wherein the grooves of the first set of pockets collectively form a cross-shaped core, wherein the grooves of the second set of pockets collectively form a cross-shaped core, and wherein the cross-shaped cores are laterally offset 45° relative to each other

12. A tool as set forth in claim 11, wherein the handle includes openings which define passageways between each pair of adjacent longitudinally aligned pockets.

13. A tool as set forth in claim 12, further comprising pivot pins which extend through the openings to pivotally attach the tool members to the handle.

14. A tool as set forth in claim 5, wherein some of the tool bits extend radially outward from the first pole when the selected tool member is in its extended position and the rest of the tool bits extend radially outward from the second pole when the selected tool member is in its extended position.

15. A tool as set forth in claim 14, further comprising springs which resiliently bias the tool members in the stored position and the extended position.

16. A tool as set forth in claim 15, wherein the springs and the tool members have a complimentary notch-groove arrangement therebetween when the tool members are in the stored position and the extended position.

17. A tool as set forth in claim 16, wherein the springs each have a cross shape and are sized for insertion into a cross-shaped cavity adjacent each of the poles.

18. A tool as set forth in claim 6, wherein the tool members each additionally comprise a proximate mounting portion pivotally attached to the handle and an intermediate portion between the proximate mounting portion and the tool bit portion, the intermediate portion and the tool bit portion extending radially outward from the handle and being aligned with the handle's axis when the selected tool member is in its extended position.

19. A tool as set forth in claim 18, wherein the proximate mounting portion includes the pivot axis for converting the tool member between the stored position and the extended position.

20. A tool as set forth in claim 19, wherein the selected tool member is rotated approximately 180° around the pivot axis when the tool member is being converted between the stored position and the extended position.

21. A tool as set forth in claim 20, further comprising a pivot pin for each of the tool members forming the pivot axis and wherein each of the pivot pins extends through an opening in the proximate mounting portion of the respective tool member.

22. A tool as set forth in claim 21, wherein the proximate portion is shaped to coordinate with a spring which biases the tool members in the stored position and in the extended position.

23. A tool as set forth in claim 22, wherein the proximate portion is also shaped to coordinate, when in its extended position, with the proximate mounting portion of a diametrically adjacent tool member.

24. A tool as set forth in claim 23, wherein the proximate mounting portion of each of the tool members includes:
a semi-circular wall section positioned tangentially relative to an adjacent longitudinal edge of a respective quadrant of a cross-shaped cavity in the handle when the tool member is in its stored position, and is rotated but remains within the quadrant when the tool member is in its extended position;
a first detent wall section capturing a notch of a spring when the tool member is in the stored position to prevent inadvertent pivoting of the tool member from the pocket;
a second detent wall section capturing the notch of the spring when the tool member is in the extended position to lock the selected tool member in its extended position; and
a concave curved wall section which mates with a semi-circular section of the diametrically adjacent tool member when the selected tool member is in the extended position to brace the tool member in position for use of the tool bit portion to perform the tooling task.

25. A tool as set forth in claim 1, wherein the handle is attachable to a keyring.

25. A tool as set forth in claim 25, wherein the handle includes an opening through which an attachment member can pass.

26. In combination, the tool of claim 1 and a keyring attached to the tool.

27. The combination of claim 26, further comprising a hook extending through an opening in the handle to attach the tool to the keyring.
